(19) United States
(12) Patent Application Publication
(10) Pub. No.: US 2012/0113474 A1
(43) Pub. Date: May 10, 2012

(54) POWER CONSUMPTION MONITORING APPARATUS, CONTROL METHOD THEREFOR, AND STORAGE MEDIUM STORING CONTROL PROGRAM THEREFOR

(75) Inventor: Ryotaro Imine, Machida-shi (JP)

(73) Assignee: CANON KABUSHIKI KAISHA, Tokyo (JP)

(21) Appl. No.: 13/289,017

(22) Filed: Nov. 4, 2011

(30) Foreign Application Priority Data
Nov. 4, 2010 (JP) 2010-247730

(51) Int. Cl. G06K 15/02

(52) U.S. Cl. 358/1.16

(57) ABSTRACT

A power consumption monitoring apparatus that is capable of monitoring electric energy consumption of an electronic apparatus even when the configuration thereof changes. A receiving unit receives job history information about the electronic apparatus. A storage unit stores a calculation table for calculating power consumed by the electronic apparatus to execute the job. A calculation unit calculates power consumption of the electronic apparatus when executing the job based on the job history information and the calculation table. An acquisition unit acquires configuration information about the electronic apparatus. A management unit manages the job history information and adds correction target information to the job history information when the configuration information is not associated with the calculation table. A correction unit corrects the power consumption in association with the job history information to which the correction target information is added based on the updated calculation table when the calculation table is updated.

### BACKGROUND OF THE INVENTION

1. Field of the Invention

The present invention relates to a power consumption monitoring apparatus, a control method therefor, and a storage medium storing a control program therefor. Particularly, the present invention relates to a technique for monitoring power consumption of an electronic apparatus that changes a configuration thereof.

2. Description of the Related Art

In recent years, apparatuses such as a printer and a multifunctional peripheral device are required to reduce power consumption in use in order to reduce the amount of emission of greenhouse gas like carbon dioxide etc. This initially requires “visualization” that enables a user to recognize the electric energy consumption of the apparatus in use.

In order to urge a user to act to reduce electric energy consumption, it is necessary to monitor the electric energy consumption of each apparatus for each job such as a print or a copy executed by each user by the “visualization”.

Therefore, there is a known technique that a monitoring apparatus, which monitors an operation state of a target apparatus, has recorded and held information about electric energy consumption corresponding to the operation state (it is referred to as “power consumption calculating information”, hereafter) beforehand, and calculates the electric energy consumption based on the operation state. In these days, there are electric products, such as energy-saving home appliances, that calculate electric power and enable the “visualization” of electric energy consumption at low cost without being equipped with measuring apparatuses, such as power consumption meters.

For example, Japanese Laid-Open Patent Publication (Kokai) No. 2006-322761 (JP 2006-322761A) discloses an electric power monitoring apparatus that calculates electric energy consumption of a target apparatus based on power consumption calculating information held beforehand and that corrects power consumption calculated result based on correction information received from the target apparatus. This aims to calculate the power consumption with sufficient accuracy by correcting a calculated result. In general, since the power consumption calculating information that has been recorded and held beforehand comprises measured values measured in a specific operation mode under a limited environment with a specific configuration for each model, an error between a measured value and a calculated value arises. The technique disclosed in JP 2006-322761A tends to reduce the error where possible.

Generally, a copier, a printer, etc. are able to extend functions by various option units (an ejection finisher etc.) in order to respond user needs. Not only a new model of a main unit of an apparatus but also a new model of such an option unit appears on the market at any time.

However, the conventional technique cannot monitor the electric energy consumption when a configuration changes, for example, when a main unit of an apparatus is replaced with a new model or a new option unit is attached.

### SUMMARY OF THE INVENTION

The present invention provides a power consumption monitoring apparatus, a control method therefor, and a storage medium storing a control program therefor, which are capable of monitoring electric energy consumption of an electronic apparatus even when the configuration of the target electronic apparatus of which electric energy consumption is monitored changes.

Accordingly, a first aspect of the present invention provides a power consumption monitoring apparatus that can communicate with an electronic apparatus, comprising a receiving unit configured to receive job history information that shows an execution history of a job that the electronic apparatus executes from the electronic apparatus concerned, a storage unit configured to store a calculation table for calculating power consumed by the electronic apparatus to execute the job based on the job history information, a calculation unit configured to calculate power consumption consumed by the electronic apparatus when executing the job corresponding to the job history information based on the job history information received by the reception unit and the calculation table stored in the storage unit, an acquisition unit configured to acquire configuration information that shows a configuration of the electronic apparatus, a management unit configured to manage the job history information in association with the power consumption calculated by the calculation unit, and to add correction target information to the job history information when the configuration information acquired by the acquisition unit includes information that is not associated with the calculation table, an update unit configured to update the calculation table stored in the storage unit, and a correction unit configured to correct the power consumption in association with the job history information to which the correction target information is added based on the updated calculation table when the update unit updated the calculation table.

Accordingly, a second aspect of the present invention provides a control method for a power consumption monitoring apparatus that can communicate with an electronic apparatus and has a storage unit for storing a calculation table for calculating power consumed by the electronic apparatus to execute a job based on job history information that shows an execution history of the job that the electronic apparatus executes, the control method comprising a receiving step of receiving job history information that shows an execution history of a job that the electronic apparatus executes from the electronic apparatus concerned, a calculation step of calculating power consumption consumed by the electronic apparatus when executing the job corresponding to the job history information based on the job history information received in the receiving step and the calculation table stored in the storage unit, an acquisition step of acquiring configuration information that shows a configuration of the electronic apparatus, a management step of managing the job history information in association with the power consumption calculated in the calculation step, and to add correction target information to the job history information when the configuration information acquired in the acquisition step includes information that is not associated with the calculation table, an update step of updating the calculation table stored in the storage unit, and a correction step configured to correct the power consumption in association with the job history information to which the correction target information is added based on the updated calculation table when the calculation table is updated in the update step.

Accordingly, a third aspect of the present invention provides a non-transitory computer-readable storage medium storing a control program causing a computer to execute a control method for a power consumption monitoring apparatus that can communicate with an electronic apparatus and has a storage unit for storing a calculation table for calculating power consumed by the electronic apparatus to execute a job based on job history information that shows an execution history of the job that the electronic apparatus executes, the control method comprising a receiving step of receiving job history information that shows an execution history of a job that the electronic apparatus executes from the electronic apparatus concerned, a calculation step of calculating power consumption consumed by the electronic apparatus when executing the job corresponding to the job history information based on the job history information received in the receiving step and the calculation table stored in the storage unit, an acquisition step of acquiring configuration information that shows a configuration of the electronic apparatus, a management step of managing the job history information in association with the power consumption calculated in the calculation step, and to add correction target information to the job history information when the configuration information acquired in the acquisition step includes information that is not associated with the calculation table, an update step of updating the calculation table stored in the storage unit, and a correction step configured to correct the power consumption in association with the job history information to which the correction target information is added based on the updated calculation table when the calculation table is updated in the update step.

According to the present invention, the electric energy consumption of an electronic apparatus can be monitored even when the configuration of the electronic apparatus changes.

Further features of the present invention will become apparent from the following description of exemplary embodiments with reference to the attached drawings.

### BRIEF DESCRIPTION OF THE DRAWINGS

FIG. 1 is a view schematically showing a configuration of a power monitoring system according to an embodiment of the present invention.

FIG. 2 is a block diagram schematically showing a configuration of a power consumption monitoring apparatus shown in FIG. 1.

FIG. 3 is a block diagram schematically showing functions of the power consumption monitoring apparatus in FIG. 2.

FIG. 4 is a block diagram schematically showing a configuration of an image forming apparatus shown in FIG. 1.

FIG. 5 is a view showing job history information recorded by a controller shown in FIG. 4.

FIG. 6A is a view showing power consumption calculating information for calculating electric energy consumption.

FIG. 6B is a view showing correction information for calculating the electric energy consumption.

FIG. 6C is a view showing power consumption calculating information about option units.

FIG. 7 is a view showing a configuration of an operation unit shown in FIG. 4.

FIG. 8 is a flowchart showing procedures of a power consumption monitoring process executed by a CPU of the image forming apparatus shown in FIG. 1.

FIG. 9 is a flowchart showing procedures of the power consumption monitoring process executed by a CPU of the power consumption monitoring apparatus shown in FIG. 1.

FIG. 10 is a flowchart showing procedures of a target registration process executed in step S201 in FIG. 9.

FIG. 11 is a view showing a power consumption monitoring target registration screen displayed in step S301 in FIG. 10.

FIG. 12 is a view showing a power consumption calculation information update setting screen displayed at the time when a power consumption information update setting button shown in FIG. 11 is depressed.

FIG. 13 is a view showing a power consumption calculation information update notifying screen.

FIG. 14 is a flowchart showing procedures of a power consumption calculating information update process executed in step S208 in FIG. 9.

FIG. 15 is a view showing a power consumption calculated result recorded in step S213 in FIG. 9.

FIG. 16 is a flowchart showing a correction process for the power consumption calculated result executed in step S403 in FIG. 14.

### DESCRIPTION OF THE EMBODIMENTS

Hereafter, embodiments according to the present invention will be described in detail with reference to the drawings.

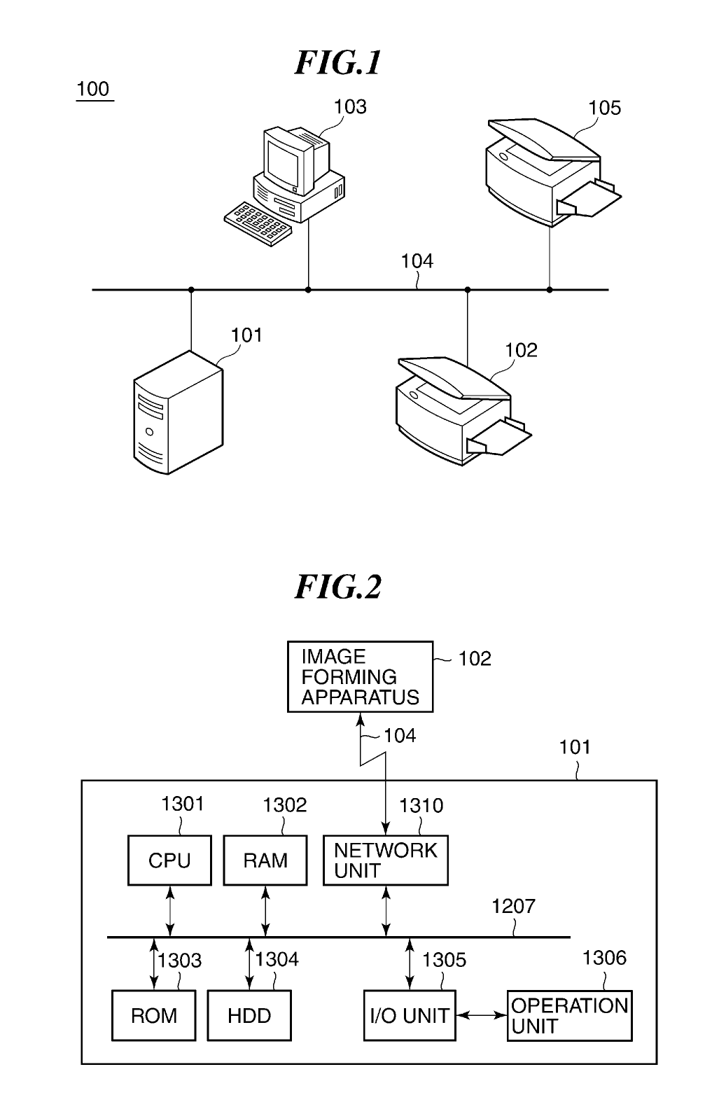

FIG. 1 is a view schematically showing a configuration of a power monitoring system according to an embodiment of the present invention.

In FIG. 1, the power monitoring system 100 includes a power consumption monitoring apparatus (a power monitor) 101, an image forming apparatuses (electronic apparatuses) 102 and 105, a general-purpose computer 103, and a network 104 that electrically connects them. The power consumption monitoring apparatus 101 can communicate with the image forming apparatus 102. It should be noted that the system configuration is not limited to the system shown in FIG. 1 that includes the two image forming apparatuses, the power monitor, and the general-purpose computer. Although the network 104 is a LAN in the embodiment, it may be constituted by a WAN, the Internet, etc. Since the image forming apparatus 105 is the same as the image forming apparatus 102, the image forming apparatus 102 will be described below as a representative.

The image forming apparatus 102 is a printer, a multifunctional peripheral device, a facsimile machine, or the like, for example. The general-purpose computer 103 transmits print data to the image forming apparatus 102. The power consumption monitoring apparatus 101 monitors electric energy consumption of the image forming apparatus 102. Specifically, the power consumption monitoring apparatus 101 receives information to which execution history of the image forming apparatus 102 is recorded (henceforth “job history information”) and configuration information. The job history information includes who used the image forming apparatus 102, when it was used, and what setting was used. For example, when the image forming apparatus 102 executes the print command received from the general-purpose computer 103, histories, such as a job type, the number of printed sheets, distinction of one-side/double-side setting, size of a recording sheet, are recorded on the job history information.

Configuration information shows a configuration of the image forming apparatus 102. For example, the configuration information shows a configuration including option units, such as an ejection finisher, a sheet feeding cassette, connected to the image forming apparatus 102.

The power consumption monitoring apparatus 101 performs a power consumption calculation process based on the job history information and the configuration information which were received from the image forming apparatus 102. The power consumption calculation process calculates electric energy consumption based on the information about the electric energy consumption corresponding to the operation state of the image forming apparatus 102 (henceforth “power consumption calculating information”). The power consumption monitoring apparatus 101 has recorded and held the power consumption calculating information (a calculation table) beforehand. The power consumption monitoring apparatus 101 manages the result calculated in this way for each the image forming apparatus.

The power monitoring system 100 is constituted so that the power consumption monitoring apparatus 101 plays a role of the apparatus that monitors electric energy consumption of a target apparatus on the network by managing the job history information and by calculating the electric energy consumption. The power consumption monitoring apparatus 101 is constituted so as to update the power consumption calculating information based on the configuration information received from the image forming apparatus 102.

Although the power consumption monitoring apparatus 101 is formed as the apparatus independent from the image forming apparatus 102 in this embodiment, the similar function may be provided inside the image forming apparatus 102.

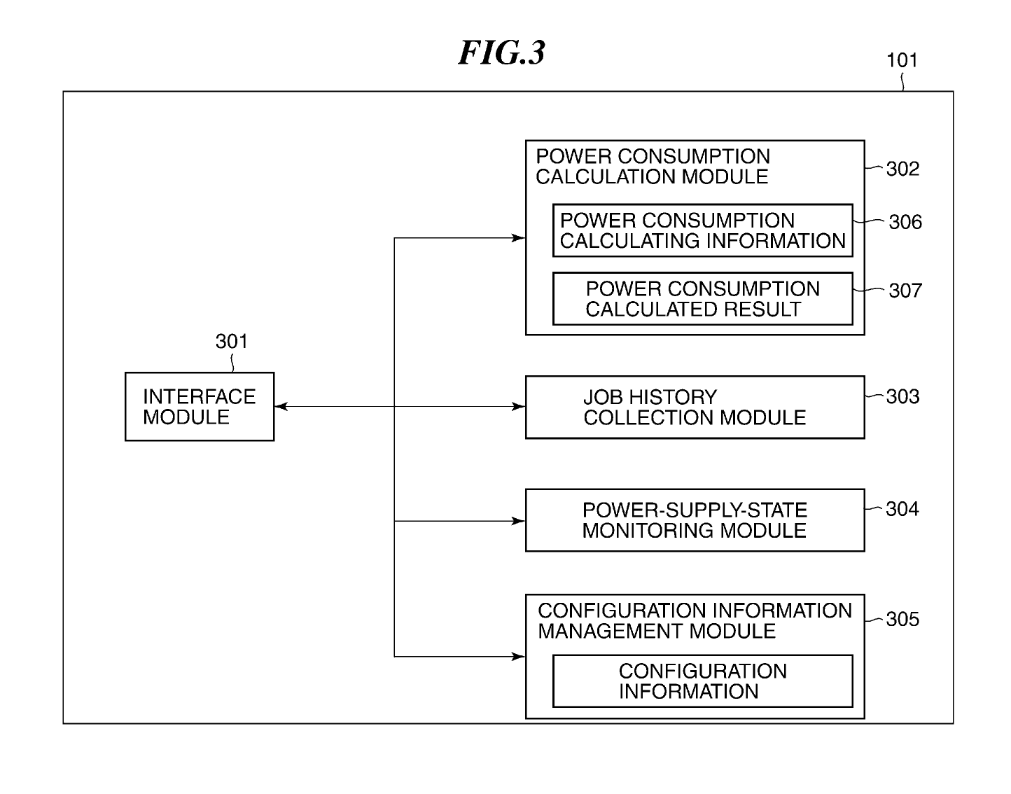

FIG. 2 is a block diagram schematically showing a configuration of the power consumption monitoring apparatus 101 shown in FIG. 1.

In FIG. 2, the power consumption monitoring apparatus 101 is provided with a CPU 1301, a RAM 1302, a ROM 1303, an HDD 1304, a network unit 1310, and an I/O unit 1305, which are mutually connected via a system bus 1207.

The CPU 1301 provides various functions by reading programs (an OS (Operating System), application software, etc.) from the HDD 1304 and by executing them. The RAM 1302 is a system work memory used as a storage area when the CPU 1301 executes a program. The ROM 1303 stores a BIOS (Basic Input Output System), a program for starting the OS, and a configuration file.

The HDD 1304 is a hard disk drive that stores system software etc. The HDD 1304 is a storage unit that stores the power consumption calculating information 306 mentioned later. The network unit 1310 is connected to the network 104 and communicates (transmits and receives) with external apparatuses, such as the image forming apparatus 102.

The I/O unit 1305 is an interface that exchanges information with an operation unit 1306 that consists of input/output devices (not shown) such as the liquid crystal display and a mouse. The liquid crystal display renders predetermined information based on screen information that a program instructs with predetermined resolution and a color number. For example, a GUI (Graphical User Interface) screen is formed to display various windows, data, etc. that are required for the operation.

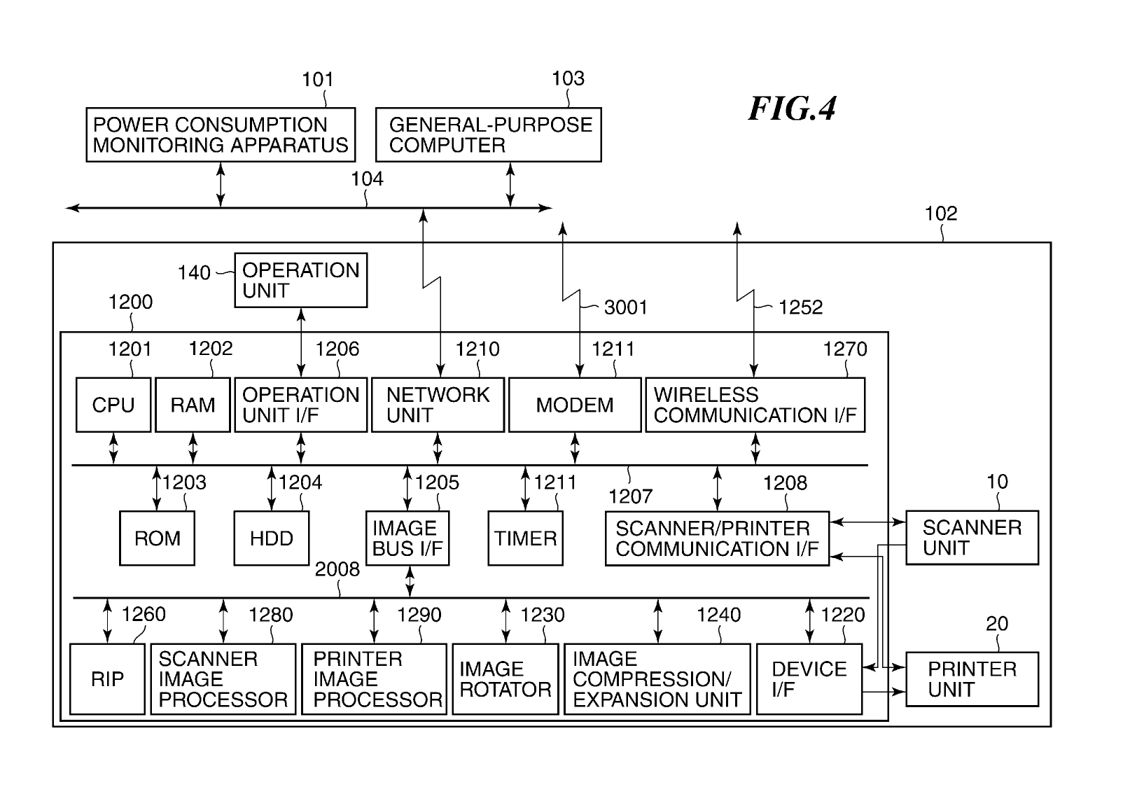

FIG. 3 is a block diagram schematically showing functions of the power consumption monitoring apparatus 101 in FIG. 2.

In FIG. 3, the power consumption monitoring apparatus 101 is provided with an interface module 301, a power consumption calculation module 302, a job history collection module 303, a power-supply-state monitoring module 304, and a target information management module 305.

The interface module 301 communicates with the image forming apparatus 102 via the network unit 1310. The power consumption calculation module 302 executes the power consumption calculation process for the image forming apparatus 102 based on a job history and a power-supply-state history using the power consumption calculating information 306, and records a power consumption calculated result 307. The job history collection module 303 collects and keeps job history information from the image forming apparatus 102 via the interface module 301. The power-supply-state monitoring module 304 receives notification of a power supply state from the image forming apparatus 102 via the interface module 301, and creates and keeps a power-supply-state history. The target information management module 305 acquires and keeps information, including the configuration information, ability information, set information, etc., from the image forming apparatus 102 via the interface module 301.

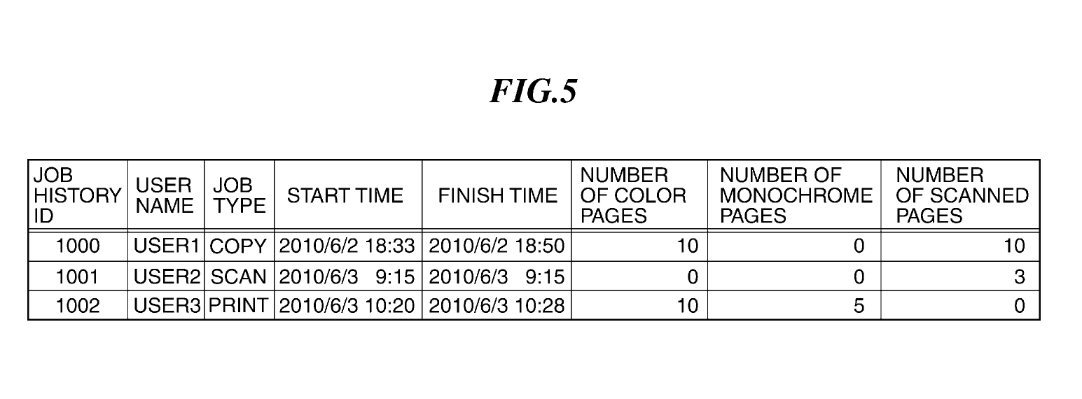

FIG. 4 is a block diagram schematically showing a configuration of the image forming apparatus 102 shown in FIG. 1.

The image forming apparatus 102 is provided with a controller 1200, an operation unit 140, a scanner unit 10, and a printer unit 20 as shown in FIG. 4.

The operation unit 140 is used by a user who uses the image forming apparatus 102 to perform various kinds of operations. The scanner unit 10 reads image information according to instructions from the operation unit 140. The scanner unit 10 has a CPU that controls the scanner unit 10 and a lighting lamp, a scanning mirror, etc. (not shown) for reading an original. The printer unit 20 prints image data onto a sheet. The printer unit 20 has a CPU that controls the printer unit and a photoconductive drum and a fixing unit (not shown) for forming and fixing an image.

The controller 1200 of the image forming apparatus 102 connects to the scanner unit 10, the printer unit 20, and the operation unit 140, and totally controls the operation of the image forming apparatus 102. The controller 1200 controls input and output of image information, device information, information about the electric energy consumption, etc.

Next, an internal configuration of the controller 1200 will be described. The controller 1200 is provided with a CPU 1201, a RAM 1202, an operation unit I/F 1206, a network unit 1210, a modem 1211, a wireless communication I/F 1270, a ROM 1203, an HDD 1204, an mage bus I/F 1205, a timer 1211, a scanner/printer communication I/F 1208, an RIP (raster image processor) 1260, a scanner image processor 1280, a printer image processor 1290, an image rotator 1230, an image compression/expansion unit 1240, and a device I/F 1220.

The CPU 1201 has control over the image forming apparatus 102. The RAM 1202 is a system work memory for an operation of the CPU 1201, and is also an image memory for storing image data temporarily. The operation unit I/F 1206 is an interface with the operation unit 140, and outputs the image data displayed on the operation unit 140 to the operation unit 140. The operation unit I/F 1206 transfers the information that the user who uses the image forming apparatus 102 has inputted from the operation unit 140 to the CPU 1201.

The network unit 1210 is connected to the network 104 in order to communicate (transmit and receive) with the general-purpose computer 103 and other computer terminals (not shown) on the network 104. The modem 1211 is connected to the public telephone line 3001, and communicates (transmits and receives) data with external facsimile machines (not shown).

The ROM 1203 stores a boot program executed by the CPU 1201. The HDD 1204 is hard disk drive that stores system software, image data, software counter values, etc. The scanner/printer communication I/F 1208 is an interface for communicating with the scanner unit 10 and the printer unit 20, respectively. The timer 1211 is used for measurement of time, etc. during the process by the controller 1200. The system bus 1207 is a bus for communications in the controller. The image bus I/F 1205 is a bus bridge that connects the system bus 1207 and an image bus 2008, and converts a data structure.

The RIP 1260 develops a PDL code that is included in a print job received from the general-purpose computer 103 into a bitmap image. The scanner image processor 1280 corrects, processes, and edits image data that is inputted from the scanner unit 10. The printer image processor 1290 corrects the image data that is outputted (printed) by the printer unit 20 and changes the resolution thereof. The image rotator 1230 converts image data to rotate the image. The image compression/expansion unit 1240 compresses multilevel image data into the JPEG format, and performs a JBIG, MMR, or MH compression/extension process to binary image data. The device I/F 1220 connects controller 1200 with the scanner unit 10 and the printer unit 20, and converts the image data between a synchronizing system and an asynchronous system. The image bus 2008 connects the image processing units mutually, and transmits image data at high speed.

The controller 1200 constituted in this way records output attribute information (a user name, the number of copies, color printing, etc.) at the time of executing a print or copy job into the HDD 1204 or the RAM 1202 as the job history information and manages it.

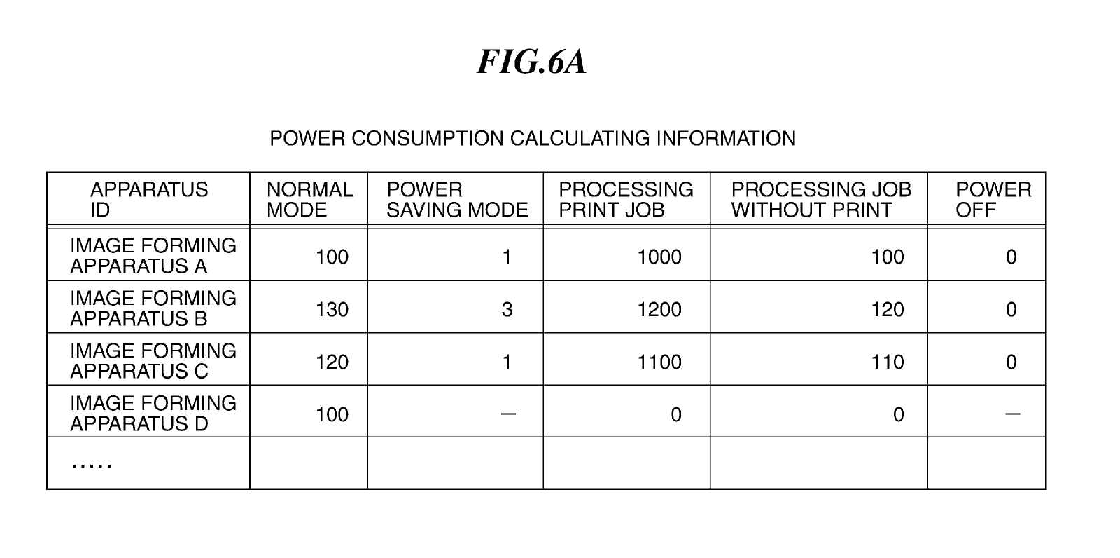

FIG. 5 is a view showing the job history information recorded by the controller 1200 shown in FIG. 4.

In FIG. 5, an ID for identifying a job history uniquely is recorded in a “job history ID” field. A name of a user who instructs a job is recorded in a “user name” field. The type of an executed job is recorded in a “job type” field. The job type includes a copy, a scan, and a print that is a print job from the general-purpose computer 103. A start time and a finish time of a job are recorded in a “start time” field and a “finish time” field, respectively. The number of color-printed pages by the job concerned is recorded in a “number of color pages” field. The number of monochrome-printed pages by the job concerned is recorded in a “number of monochrome pages” field. The number of pages scanned by the scanner unit 10 is recorded in a “number of scanned pages” field. The number of color scanned pages and the number of monochrome scanned pages may be distinguished and recorded.

The job history information table may be created for each job type. The job history information about a job issued by the operation unit 140 (for example, a copy job) is acquired from the operation unit I/F 1206. The job history information about a job issued by the general-purpose computer 103 or other terminals (for example, a print job) is acquired from the network unit 1210.

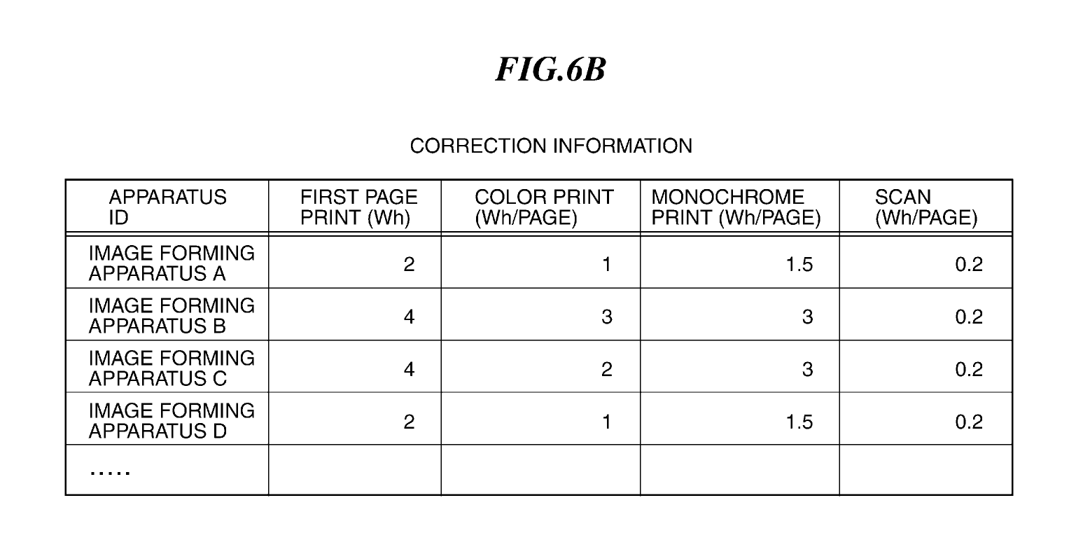

FIG. 6A is a view showing power consumption calculating information for calculating electric energy consumption. FIG. 6B is a view showing correction information for calculating the electric energy consumption. FIG. 6C is a view showing power consumption calculating information about option units.

In FIG. 6A, information for identifying an image forming apparatus is recorded in an “apparatus ID” field. The apparatus ID shows the type of an image forming apparatus. The electric energy consumption in a normal mode is recorded in a “normal mode” field. The electric energy consumption in a power saving mode is recorded in a “power saving mode” field. The electric energy consumption in a print job process is recorded in a “processing print job” field. The copy job or the like is equivalent to the print job. The electric energy consumption in a job process that does not execute a print process is recorded in a “processing job without print” field. The scan job is equivalent to the job without print. The electric energy consumption in a power OFF state is recorded in a “power OFF” field.

The correction information in FIG. 6B is used when the electric energy consumption is corrected to be calculated. The electric energy consumption for printing a first page is recorded in a “first page print” field. The electric energy consumption for printing one page in a color printing mode is recorded in a “color print” field. The electric energy consumption for printing one page in a monochrome printing mode is recorded in a “monochrome print” field. The electric energy consumption for scanning one page is recorded in a “scan” field.

FIG. 6C is a view showing an example of power consumption calculating information about option units. Information for identifying an option unit is recorded in an “option ID” field. The electric energy consumption where a sheet size is A4 is recorded in a “sheet size: A4” field. The electric energy consumption where a sheet size is A3 is recorded in a “sheet size: A3” field.

It should be noted that the recording items for the power consumption calculating information, the correction information, and the option unit are not restricted to the items shown in FIGS. 6A, 6B, and 6C.

FIGS. 6A and 6B show the tables that store the information about the electric energy that will be consumed by the image forming apparatus that can equip with an option unit for each process executed by each type of the image forming apparatus. FIG. 6C shows the table that stores the information about the electric energy that will be consumed by the option unit for each process executed by each option unit.

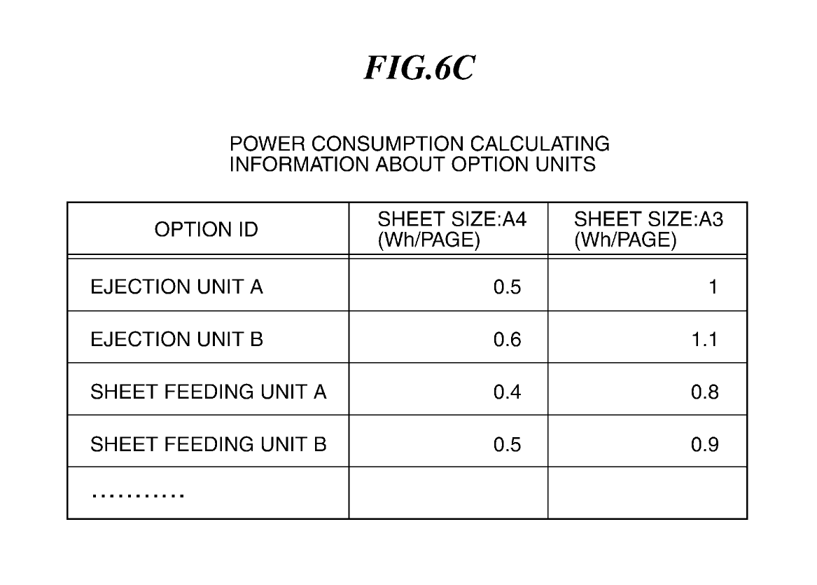

FIG. 7 is a view showing a configuration of the operation unit 140 shown in FIG. 4.

In FIG. 7, the operation unit 140 is provided with a liquid crystal operation panel 61, a start key 62, a stop key 63, a hard key group 64, and a power-saving key 65.

The liquid crystal operation panel 61 is a combination of a liquid crystal display and a touch panel, displays an operation screen, and transmits information about an operation by a user on the operation screen to the controller 1200. The start key 62 is used for starting a copy operation of an original image, and a start instruction of another function. The start key 62 is equipped with a green LED and a red LED. Lighting of the green LED in the start key 62 shows that an operation can start. Lighting of the red LED shows that an operation cannot start. The stop key 63 has a function for stopping an operation in action. The hard key group 64 is provided with a ten-key pad, a clear key, a reset key, a guide key, and a user mode key.

The power-saving key 65 is used to shift the image forming apparatus 102 from the normal mode to a sleep mode or to return it from the sleep mode to the normal mode. In the image forming apparatus 102, the mode is shifted to the sleep mode when the power-saving key 65 is pressed in the normal mode. On the other hand, the mode is shifted to the normal mode when the power-saving key 65 is pressed in the sleep mode. The operation unit 140 transmits the information required for creating job information (the user name, the number of copies, the output attribute information, which are inputted using the liquid crystal operation panel 61) to the operation unit I/F 1206.

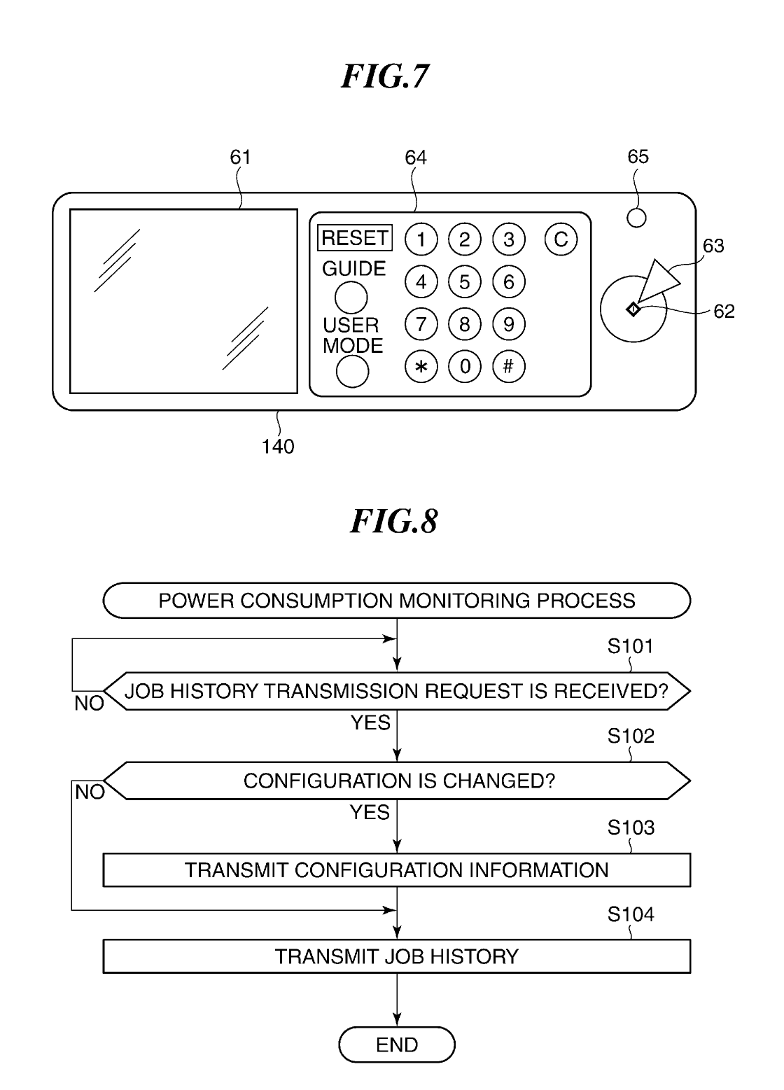

FIG. 8 is a flowchart showing procedures of a power consumption monitoring process executed by the CPU 1201 of the image forming apparatus 102 shown in FIG. 1.

In FIG. 8, the CPU 1201 determines whether a job history transmission request that requests the job history information transmitted from the power consumption monitoring apparatus 101 (step S101). When receiving the job history transmission request (YES in the step S101), the CPU 1201 determines whether the configuration of the image forming apparatus 102 was changed after receiving the job history transmission request last time up to now (step S102). When the configuration was changed (YES in the step S102), the CPU 1201 transmits the current configuration information to the power consumption monitoring apparatus 101 (step S103), and proceeds with the process to step S104. On the other hand, when the configuration was not changed as a result of determination in the step S102, the CPU 1201 skips the step S103 and proceeds with the process to step S104. Next, the CPU 1201 transmits the job history in response to the job history transmission request to the power consumption monitoring apparatus 101 (step S104), and finishes this process.

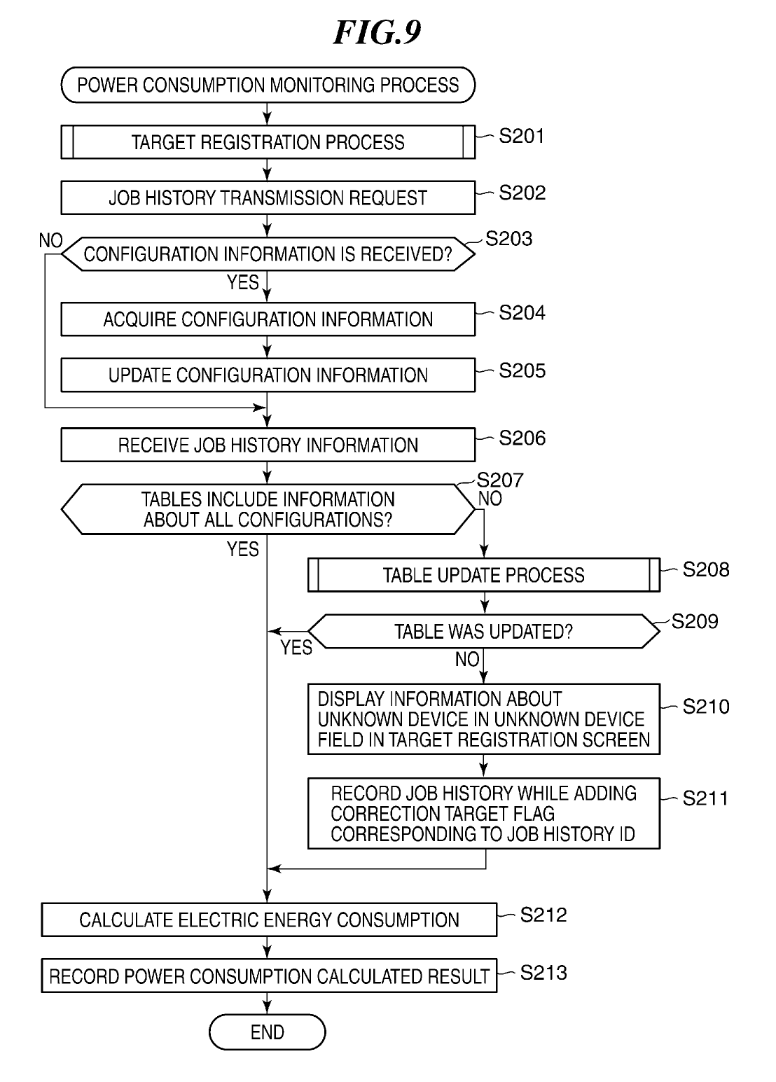

FIG. 9 is a flowchart showing procedures of the power consumption monitoring process executed by the CPU 1301 of the power consumption monitoring apparatus 101 shown in FIG. 1.

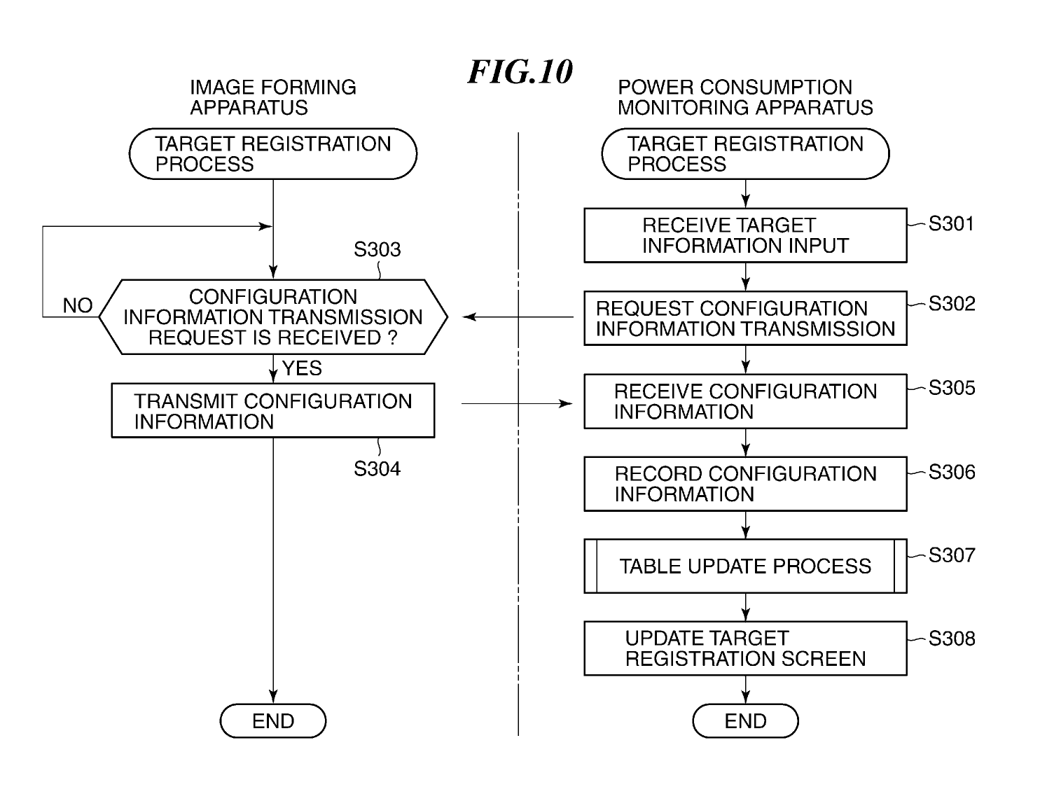

In FIG. 9, the CPU 1301 registers a target apparatus of which electric energy consumption is monitored by executing a target registration process in FIG. 10 mentioned late (step S201). According to this process, the CPU 1301 receives the input to the operation unit 1306 with which the power consumption monitoring apparatus 101 is provided, and performs an initial setting to the power consumption monitoring target apparatus (the image forming apparatus 102). Next, the CPU 1301 transmits the job history transmission request mentioned above to the image forming apparatus 102 (step S202).

Next, the CPU 1301 determines whether the configuration information, which shows the type of the image forming apparatus 102 and the option unit attached to the image forming apparatus 102, is received from the image forming apparatus 102 (step S203). When receiving the configuration information (YES in the step S203), the CPU 1301 acquires the configuration information (step S204), updates the configuration information in the target information management module 305 (step S205), and proceeds with the process to step S206. On the other hand, when the configuration information is not received (NO in the step S203), the CPU 1301 proceeds with the process to step S206. Then, the CPU 1301 receives the job history information (step S206), and records it to the job history collection module 303.

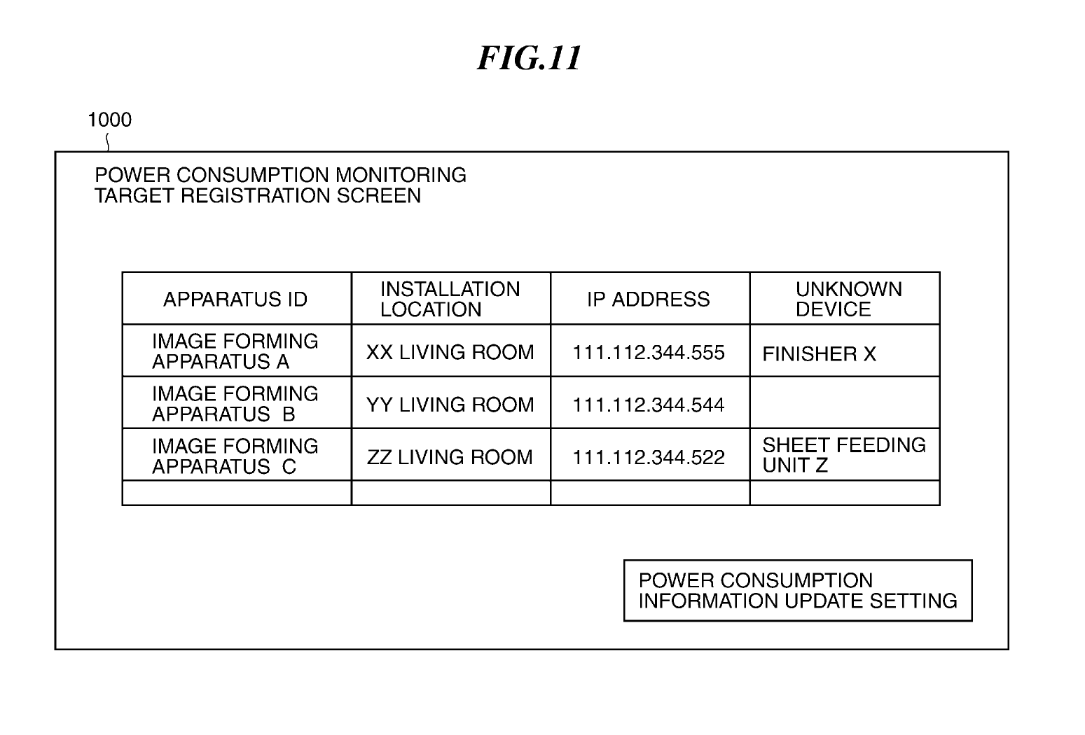

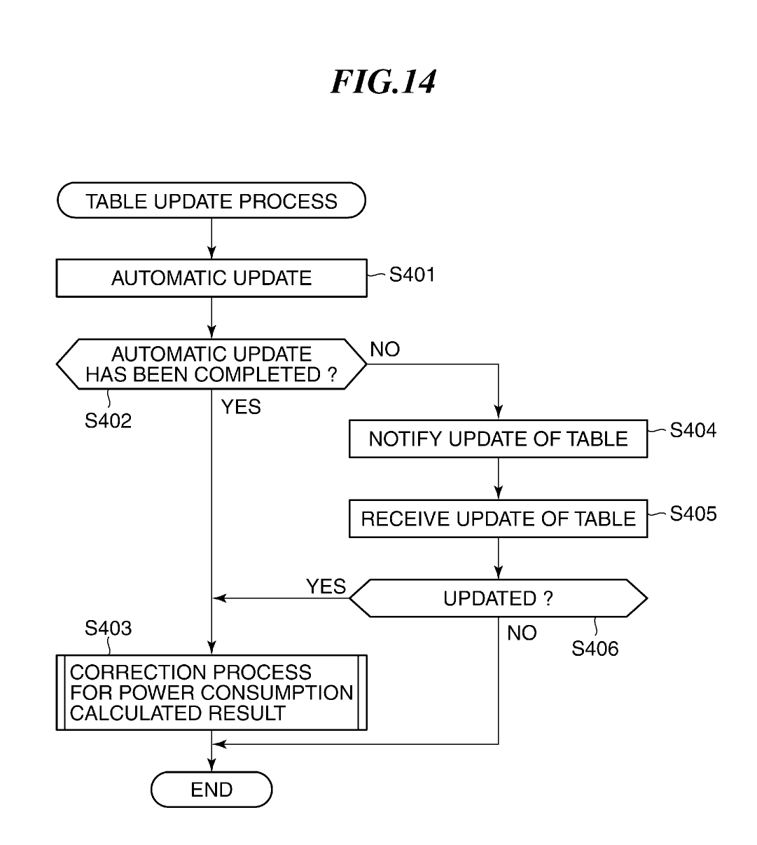

Next, the CPU 1301 determines whether the power consumption calculating information, which is defined in the tables in FIG. 6A, FIG. 6B, and FIG. 6C, in the power consumption calculation module 302 includes the information about all the configurations (step S207). When the information of all the configurations is included in the power consumption calculating information, the CPU 1301 proceeds with the process to step S212. On the other hand, when the information about not all the configurations is included in the power consumption calculating information (NO in the step S207), the CPU 1301 executes a power consumption calculating information update process in FIG. 14 mentioned later to update the power consumption calculating information (step S208). Next, the CPU 1301 determines whether the power consumption calculating information was updated (step S209). When the information was not updated (NO in the step S209), the CPU 1301 displays the information about a device that is not included in the power consumption calculating information in an unknown device field in a target registration screen in FIG. 11 mentioned later (step S210), records the job history that is a target to calculate the electric energy consumption by adding a correction target flag (correction needed information) corresponding to the job history ID (step S211), and proceeds with the process to step S212. On the other hand, when the power consumption calculating information was updated (YES in the step S209), the CPU 1301 proceeds with the process to step S212. This correction target flag is information showing that the electric energy consumption was calculated using the power consumption calculating information that was not updated. Specifically, the flag shows whether the correction is necessary because the information is not included in the power consumption calculating information. Then, ON of the correction target flag shows that a correction is necessary, and OFF shows that a correction is unnecessary.

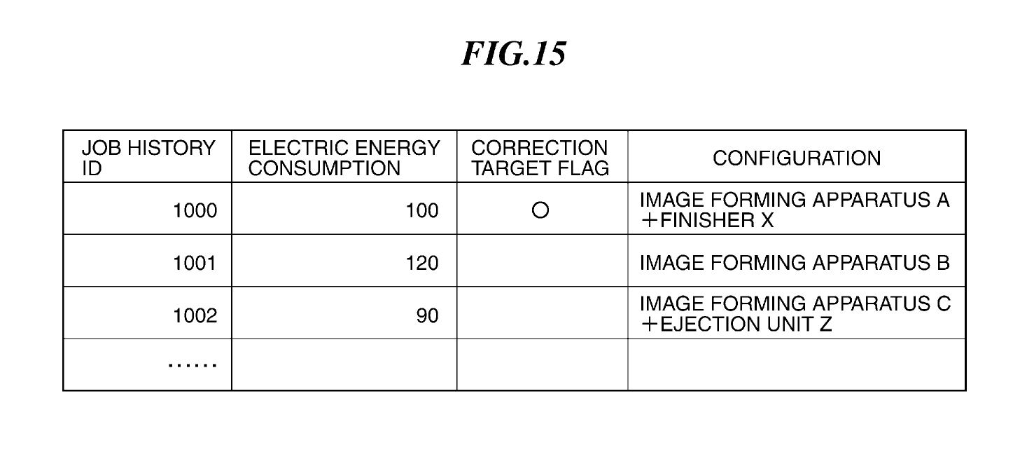

The CPU 1301 calculates the electric energy consumption using the power consumption calculating information for each process that the image forming apparatus 102 and the option unit executed (step S212). Then, the CPU 1301 records the power consumption information that shows the calculated electric energy consumption as the power consumption calculated result (see FIG. 15) (step S213), and finishes this process.

The power consumption calculation process in the step S212 is performed according the following formulas, for example.

First, job processing time is calculated from the job start time and the job finish time in the job history information 400.

[Job processing time]=[job finish time]−[job start time]

Next, the electric energy consumption is calculated with the following equations.

[Electric energy consumption]=[processing print job]*[job processing time]+[first page print]+[color print]*[number of color pages]

According to the process in FIG. 9, when the information showing the electric energy consumption of the type and the option unit of the image forming apparatus 102 that is shown by the configuration information acquired in the step S204 is not included in the power consumption calculating information (NO in the step S207), the CPU 1301 updates the power consumption calculating information (the step S208) by acquiring the information showing the electric energy that is not included in the power consumption calculating information. Therefore, the electric energy consumption of the target electronic apparatus, which can be equipped with the option unit, can be monitored even if the configuration of the target electronic apparatus changes.

Moreover, according to the process in FIG. 9, when the power consumption calculating information cannot be updated (NO in the step S209), the CPU 1301 records the power consumption information by adding the correction target flag that shows that the electric energy consumption was calculated using the power consumption calculating information that was not updated (step S211).

Furthermore, according to the process in FIG. 9, since the CPU 1301 calculates the electric energy consumption for each process executed by the image forming apparatus 102 and the option unit (the step S212), the user can grasp the electric energy consumption in more detail.

FIG. 10 is a flowchart showing procedures of the target registration process executed in the step S201 in FIG. 9.

Since the image forming apparatus 102 also operates when this process is executed, the process in the image forming apparatus 102 will be also described in addition.

In FIG. 10, the power consumption monitoring apparatus 101 receives an input of information including an IP address and an installation location of an apparatus that will be registered on a registration screen (FIG. 11) for registering the apparatus of which electric energy consumption will be monitored (step S301). And then, the power consumption monitoring apparatus 101 requests the image forming apparatus 102 to transmit the configuration information with respect to the apparatus of which the input was received (step S302).

Next, the image forming apparatus 102 determines whether the configuration information transmission request is received (step S303). When determining that the configuration information transmission request was received, the image forming apparatus 102 transmits the configuration information to the power consumption monitoring apparatus 101 (step S304).

Next, the power consumption monitoring apparatus 101 receives the configuration information from the image forming apparatus 102 (step S305), and records the received configuration information to the target information management module 305 (step S306). Next, the power consumption monitoring apparatus 101 performs the power consumption calculating information update process shown in the FIG. 14 mentioned later (step 307), updates contents on an target registration screen based on the configuration information and a power consumption calculating information updated result (step S308), and finishes this process.

FIG. 11 is a view showing a power consumption monitoring target registration screen 1000 displayed in the step S301 in FIG. 10.

The power consumption monitoring target registration screen 1000 comprises an “apparatus ID” field, an “installation location” field, an “IP address” field, an “unknown device” field, and a power consumption information update setting button.

Information for identifying an image forming apparatus is recorded in the “apparatus ID” field. A location where the image forming apparatus is installed is recorded in the “installation location” field. An IP address of the image forming apparatus is recorded in the “IP address” field. Information about a device that is not included in the power consumption calculating information is recorded in the “unknown device” field. The power consumption information update setting button is used for shifting to a power consumption calculation information update setting screen.

The power consumption monitoring target registration screen 1000 in FIG. 11 is an example. It is not limited to the illustrated example, when the screen includes the apparatus ID, which identifies the target apparatus of which electric energy consumption is monitored, and the corresponding unknown device at least, and when the user can distinguish whether the configuration information of the target apparatus includes the information that is not included in the power consumption calculating information.

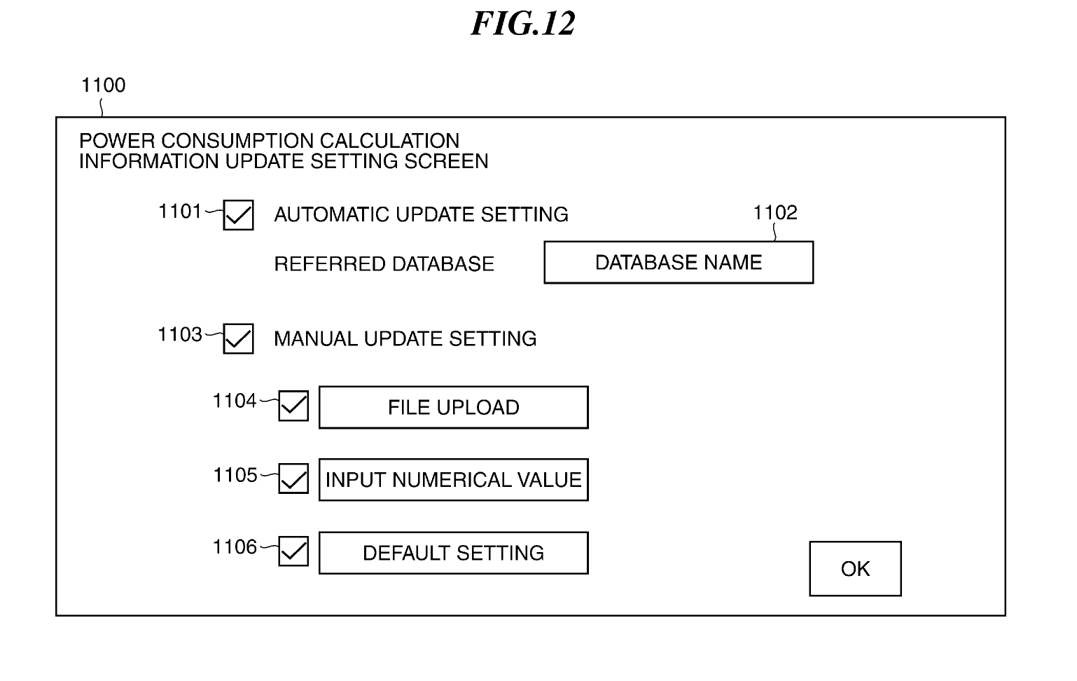

FIG. 12 is a view showing the power consumption calculation information update setting screen 1100 displayed at the time when the power consumption information update setting button shown in FIG. 11 is depressed.

In FIG. 12, the power consumption calculation information update setting screen 1100 comprises a check box 1103 for enabling an automatic update setting, a column 1102 for designating a database to be referred during the automatic update, and a check box 1103 for enabling a manual update setting. Further, the screen 1100 is provided with a check box 1104 for enabling the manual update method by uploading a file, a check box 1105 for enabling the manual update method by inputting numeral values directly, and a check box 1106 for enabling the manual update method using a predetermined default setting.

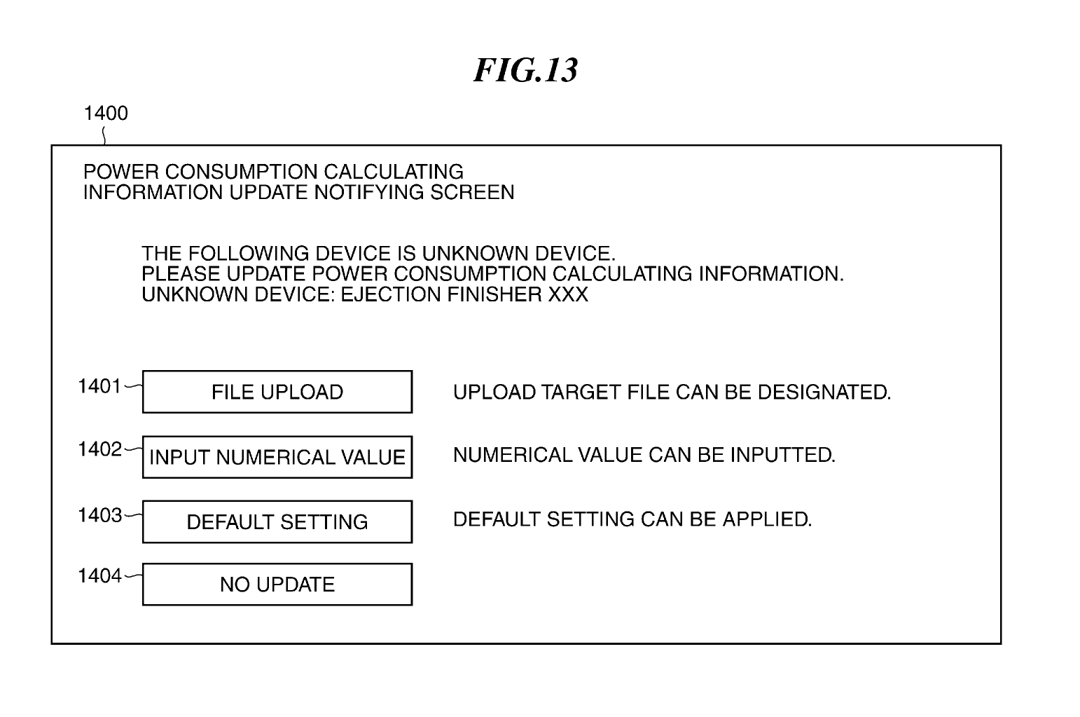

FIG. 13 is a view showing a power consumption calculation information update notifying screen 1400.

The power consumption calculating information update notifying screen 1400 is displayed when the automatic update has not been completed even when the automatic update setting is effective.

The power consumption calculating information update notifying screen 1400 displays buttons 1401 through 1403 that represent the manual update methods that are enabled in FIG. 12 as choices. In the illustrated example, the update button 1401 by uploading a file, the update button 1402 by inputting numerical values, the update button 1403 by applying the default setting, and a selection button 1404 for no update are displayed.

FIG. 14 is a flowchart showing procedures of the power consumption calculating information update process executed by the CPU 1301 of the power consumption monitoring apparatus 101 shown in FIG. 1.

In FIG. 14, the CPU 1301 automatically updates the power consumption calculating information first (step S401). In the automatic update, the CPU 1301 acquires the information that shows the electric energy and is not included in the power consumption calculating information from an external database (not shown) connected via the network, and updates the power consumption calculating information using the acquired information that shows the electric energy. Specifically, the CPU 1301 adds the acquired information that shows the electric energy to the power consumption calculating information 306.

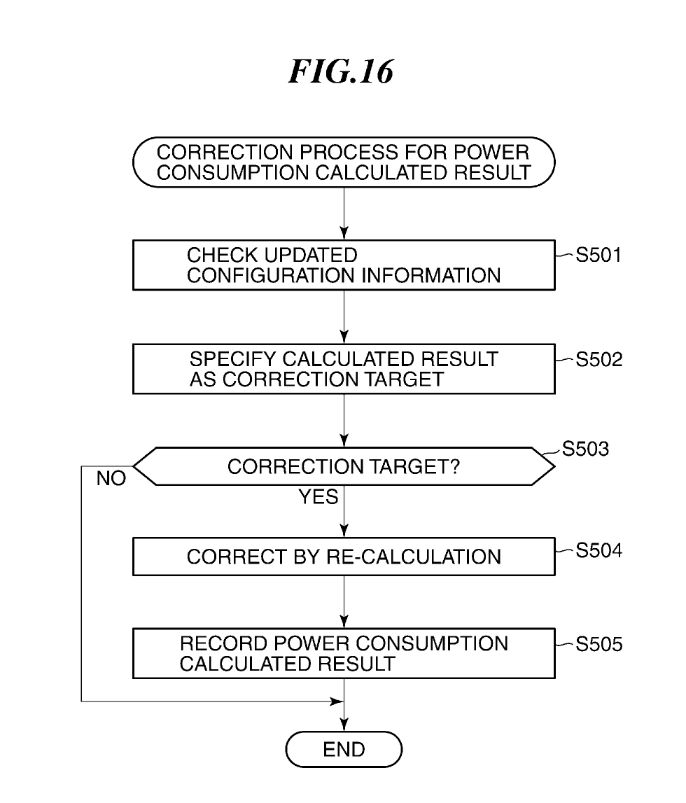

Next, the CPU 1301 determines whether the automatic update has been completed (step S209). When the automatic update has been completed (YES in the step S402), the CPU 1301 executes the correction processing for the power consumption calculated result in FIG. 16 mentioned later (step 403), and finishes this process.

On the other hand, when the automatic update has not been completed (NO in the step S402), the CPU 1301 notifies a user to update the power consumption calculating information in order to urge the manual update (step S404). Here, the CPU 1301 urges the manual update by showing an update procedure according to the manual update method set in the setting screen shown in FIG. 12 and by receiving an input.

Next, the CPU 1301 receives the update of the power consumption calculating information (step S405), and determines whether the manual update has been completed (step S406). When the information has been updated by the manual operation, the CPU 1301 executes the correction processing for the power consumption calculated result in FIG. 16 mentioned later (the step S403). When the information has not been updated, the CPU 1301 finishes this process immediately.

FIG. 15 is a view showing the power consumption calculated result recorded in the step S213 in FIG. 9.

The power consumption calculated result is recorded in the power consumption calculation module 302. Then, the power consumption calculated result comprises a “job history ID” field, an “electric energy consumption” field, a “correction target flag” field, and a “configuration” field. An ID for identifying a job history uniquely is recorded in the “job history ID” field. Electric energy consumed by the job is recorded in the “electric energy consumption” field. Information for identifying an image forming apparatus and information for specifying an option unit are recorded in the “configuration” field. FIG. 15 shows the example for recording information about the image forming apparatuses A, B, and C.

The recording method for the calculated result in the power consumption monitoring apparatus according to the present invention is not limited to the illustrated method. That is, the recording method merely requires that the electric energy consumption and the correction target flag corresponding to the job history and the configuration information at the time of execution of the job are recorded to be searchable.

FIG. 16 is a flowchart showing the correction process for the power consumption calculated result executed in the step S403 in FIG. 14.

The correction process corrects the calculated result based on the correction target flag by re-calculating the calculation result of which job history ID was recorded as an unknown device because the information thereof was not included in the power consumption calculating information.

In FIG. 16, the CPU 1301 checks the configuration information of which the power consumption calculating information was updated (step S501), retrieves the power consumption calculated result, and specifies the calculated result of the correction target by checking the correction target flag of the calculated result (step S502). Next, the CPU 1301 determines whether the specified calculated result is the correction target of the apparatus checked in the step S501 (step S503). When it is the correction target, the CPU 1301 corrects the calculated result by re-calculating based on the updated power consumption calculating information (step S504), releases the correction target flag, records the calculated result again (step S505), and finishes this process. On the other hand, when the specified calculated result is not the correction target (NO in the step S503), the CPU 1301 finishes this process.

According to the process in FIG. 16, when the power consumption information to which the correction target flag is added exists and when the power consumption calculating information is updated (YES in the step S503), the CPU 1301 corrects the power consumption information to which the correction target flag is added by re-calculating the electric energy consumption using the updated power consumption calculating information (step S504). Therefore, more exact electric energy consumption can be obtained.

The above embodiment describes the system in which the electric energy consumption is calculated by the power consumption monitoring apparatus 101 other than the image forming apparatus 102. Another embodiment in which the image forming apparatus 102 calculates the electric energy consumption will be described.

In order to achieve the power consumption monitoring function by the image forming apparatus 102, the programs for executing the functional block shown in FIG. 3 are stored in the HDD 1204 or the RAM 1202 of the image forming apparatus, and are executed by the CPU 1201. The operation setting screens shown in FIG. 11 and FIG. 12 are displayed on the liquid crystal operation panel 61 of the operation unit 140 with which the image forming apparatus 102 is provided (see FIG. 7) and receive inputs.

The image forming apparatus 102 that is provided with the power consumption monitoring function can monitor not only the electric energy consumption thereof, but also the electric energy consumption of other image forming apparatuses. The power consumption monitoring functions for the other apparatuses can be set by inputs through the operation setting screens shown in FIG. 11 and FIG. 12.

The above-described flowcharts (FIGS. 8, 9, 10, 14, and 16) are strictly examples. An existing step may be deleted and a new step may be inserted as long as it does not deviate from the scope of the present invention.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-247730, filed on Nov. 4, 2010, which is hereby incorporated by reference herein in its entirety.

What is claimed is:

1. A power consumption monitoring apparatus that can communicate with an electronic apparatus, comprising:
a receiving unit configured to receive job history information that shows an execution history of a job that the electronic apparatus executes from the electronic apparatus concerned;
a storage unit configured to store a calculation table for calculating power consumed by the electronic apparatus to execute the job based on the job history information;
a calculation unit configured to calculate power consumption consumed by the electronic apparatus when executing the job corresponding to the job history information based on the job history information received by said reception unit and the calculation table stored in said storage unit;
an acquisition unit configured to acquire configuration information that shows a configuration of the electronic apparatus;
a management unit configured to manage the job history information in association with the power consumption calculated by said calculation unit, and to add correction target information to the job history information when the configuration information acquired by said acquisition unit includes information that is not associated with the calculation table;
an update unit configured to update the calculation table stored in said storage unit; and
a correction unit configured to correct the power consumption in association with the job history information to which the correction target information is added based on the updated calculation table when said update unit updated the calculation table.

2. The power consumption monitoring apparatus according to claim 1, wherein said calculation unit calculates electric energy consumption for each process executed by each device that constitutes the electronic apparatus.

3. A control method for a power consumption monitoring apparatus that can communicate with an electronic apparatus and has a storage unit for storing a calculation table for calculating power consumed by the electronic apparatus to execute a job based on job history information that shows an execution history of the job that the electronic apparatus executes, the control method comprising:
a receiving step of receiving job history information that shows an execution history of a job that the electronic apparatus executes from the electronic apparatus concerned;
a calculation step of calculating power consumption consumed by the electronic apparatus when executing the job corresponding to the job history information based on the job history information received in said receiving step and the calculation table stored in the storage unit;
an acquisition step of acquiring configuration information that shows a configuration of the electronic apparatus;
a management step of managing the job history information in association with the power consumption calculated in said calculation step, and to add correction target information to the job history information when the configuration information acquired in said acquisition step includes information that is not associated with the calculation table;
an update step of updating the calculation table stored in the storage unit; and
a correction step configured to correct the power consumption in association with the job history information to which the correction target information is added based on the updated calculation table when the calculation table is updated in said update step.

4. The control method for the power consumption monitoring apparatus according to claim 3, wherein electric energy consumption for each process executed by each device that constitutes the electronic apparatus is calculated in said calculation step.

5. A non-transitory computer-readable storage medium storing a control program causing a computer to execute a control method for a power consumption monitoring apparatus that can communicate with an electronic apparatus and has a storage unit for storing a calculation table for calculating power consumed by the electronic apparatus to execute a job based on job history information that shows an execution history of the job that the electronic apparatus executes, the control method comprising:
a receiving step of receiving job history information that shows an execution history of a job that the electronic apparatus executes from the electronic apparatus concerned;
a calculation step of calculating power consumption consumed by the electronic apparatus when executing the job corresponding to the job history information based on the job history information received in said receiving step and the calculation table stored in the storage unit;
an acquisition step of acquiring configuration information that shows a configuration of the electronic apparatus;
a management step of managing the job history information in association with the power consumption calculated in said calculation step, and to add correction target information to the job history information when the configuration information acquired in said acquisition step includes information that is not associated with the calculation table;
an update step of updating the calculation table stored in the storage unit; and
a correction step configured to correct the power consumption in association with the job history information to which the correction target information is added based on the updated calculation table when the calculation table is updated in said update step.
